(19) United States
(12) Patent Application Publication
(10) Pub. No.: US 2024/0198742 A1
(43) Pub. Date: Jun. 20, 2024

(54) METHOD FOR ESTIMATING POTENTIAL TIRE-TO-GROUND ADHESION

(71) Applicant: COMPAGNIE GENERALE DES ETABLISSEMENTS MICHELIN, Clermont-Ferrand (FR)

(72) Inventors: JEREMY VAYSSETTES, Clermont-Ferrand (FR); VINCENT ARVIS, Clermont-Ferrand (FR); VINCENT MUSSOT, Clermont-Ferrand (FR); THIBAULT DAIRAY, Clermont-Ferrand (FR)

(21) Appl. No.: 18/286,502

(22) PCT Filed: Apr. 11, 2022
(86) PCT No.: PCT/FR2022/050682

§ 371 Date: Oct. 11, 2023

(30) Foreign Application Priority Data
Apr. 12, 2021 (FR) FR2103733

(51) Int. Cl. B60C 99/00; B60W 40/064; B60W 50/00

(52) U.S. Cl. CPC B60C 99/006; B60W 40/064; B60W 2050/0033; B60W 2530/20

(57) ABSTRACT

The rolling parameters of a tire on a rolling surface are evaluated, and more specifically a tire's adhesion potential on a rolling surface is estimated. A method and a system enabling such estimation are disclosed.

The present invention relates to the field of evaluation of the rolling parameters of a tire on a rolling surface, and more specifically relates to the estimation of a tire's potential tire-to-ground adhesion.

With the continuing development of on-board technologies, it is becoming possible to obtain increasing amounts of information regarding a vehicle's driving conditions. It is therefore useful, in order to supply the various driver assistance and safety systems in vehicles, to know in real time the potential adhesion of a tire on a given surface in order to be able to prevent any risk of skidding caused by a loss of adhesion. For the sake of clarity, it is specified here that throughout the description, the symbol μ or the term “mu” will be used to designate the adhesion coefficient of a tire on the rolling surface.

Numerous scientific publications and patent documents describing methods for estimating such parameters are known in this field. For example, mention may be made of patent document EP3028909A1, which relates to an intelligent method for estimating the level of adhesion of a road.

The existing methods may be classified into two broad categories:
methods that employ one or more specific sensors, installed on the vehicles, for example acoustic, thermal or optical sensors, and
sensorless methods that rely on reconstructing information from available vehicle data.

Methods of the first kind have a major disadvantage in terms of cost, industrial intrusiveness on the vehicles, and equipment maintenance. This disadvantage is not found with sensorless methods. However, to date, there is no sensorless method that can assure a good level of estimation under all load conditions. Thus, a method using an aligning-torque value is known but has the disadvantage of working only for conditions of light stress loading, because the aligning-torque value becomes saturated more rapidly than the lateral force. Another method uses a tire model but does not take into account the thermal characteristics of the tire, thus falsifying the values determined for low loads. However, all of these existing methods are based on the common principle of accurately estimating the maximum adhesion when it is attained or close to being attained (between 80% and 100% of maximum adhesion). However, none of these methods is able to estimate a maximum adhesion under low-load conditions, e.g., when the running conditions are such that the load is below 40% of maximum mu.

Machine-learning methods are also known, that use no source of information regarding the physical operation of the tire. Those methods, however, require learning very complex learning processes that are very cumbersome to implement, and no method has proven to be effective.

Finally, it has been noted that many methods aim to estimate an adhesion potential when it has bene attained or is close to being attained, so as to trigger immediate corrective action on a vehicle. Such is the case, for example, with the methods employed by ABS and ESP systems that are now widely deployed on heavy goods vehicles and passenger vehicles. Nevertheless, these methods are unable to provide a preventive estimate of adhesion, which would enable the vehicle's behavior to be modified ahead of time so that as to avoid having to initiate corrective action.

The present invention therefore proposes a method that can remedy the numerous drawbacks of the prior art.

Thus, the invention relates to a method for estimating a tire's adhesion potential on a rolling surface, the tire being installed on a vehicle equipped with the method including the following steps:
a first step of estimating a force experienced by the tire as a function of a vehicle model and of a state observer,
a second step of estimating a force experienced by the tire as a function of a thermomechanical model of the tire,
a step of statistical comparison of the forces determined during the first and second estimating steps, and
a step of determining, as a function of the result of this comparison step, a value of the tire/ground adhesion potential.

The first estimating step makes it possible to observe the forces generated by each axle and transcribed to the wheel center. This step is based on a vehicle model that will be described later on with the aid of the figures.

In a preferred embodiment, the vehicle model is bicycle model and/or the state observer is a Kalman filter.

The use of a thermomechanical tire model in the second estimating step provides a good representation of the various physical phenomena that affect adhesion potential, such as the impact of temperature, for example. By taking thermal effects into account, it is possible to offer a much more reliable method than those currently available.

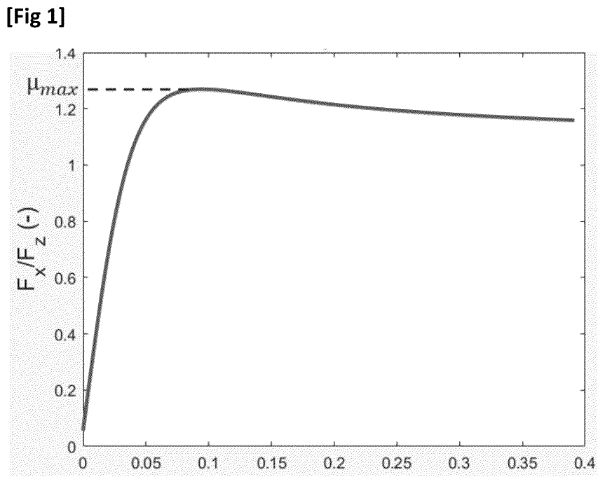

As illustrated in FIG. 1, the adhesion potential corresponds to the maximum of the longitudinal friction force curve normalized as a function of slip rate. This maximum is indicated by μₘₐₓ on the curve of FIG. 1, which on the abscissa axis shows a slip rate of between 0 and 0.4, and on the ordinate axis shows the longitudinal friction force Fₓ divided by the vertical load F_{z}.

The value of μₘₐₓ needs to be able to be estimated even at low loads, namely in the linear part of the curve of FIG. 1 (slip of less than 0.08). Now, it has been found that the gradient of this linear part is dependent on several parameters, and notably on the temperature. Thus, failure to take thermal effects into account prevents the adhesion potential from being estimated correctly at low loads. The same applies to other parameters such as pressure, load or wear.

Depending on the embodiment, there are several methods that can be used for performing the comparison step and determining an adhesion potential. These include methods employing Bayesian logic, such as the Monte-Carlo Markov Chain method. These methods will be described in detail later.

In one embodiment, the thermomechanical model of the tire includes a model of the longitudinal forces, the transverse forces, a self-aligning torque, and a balance of the elementary shear and sliding forces on the tire at a transition point between the adhering and sliding contact zones. This model is notably described in patent applications EP2057567 and EP2062176. However, the invention is not restricted to this embodiment and any thermomechanical tire model may be used. However, it is preferable to use a thermomechanical model that considers at least inflation pressure, applied load and tire wear.

In one embodiment, a method according to the invention includes, at least before the second estimating step, a step of reducing the tire model. This feature makes it possible to implement a method according to the invention in real time.

This reduction step advantageously includes the following sub-steps:
generating an observation matrix using the thermodynamic model for different values of the tire parameters, such as load, pressure or temperature,
calculating the values and singular vectors of this matrix,
calculating the projection coefficients at the observation times, and
performing an interpolation that can be used for all parameter values.

In this way, the use of a reduced model avoids the need to calculate the complete model at each time step, thereby reducing the computational resources required and enabling the model to be embedded in the vehicle for real-time determination.

The invention also relates to a system for estimating the adhesion potential of a tire on a rolling surface, the tire being installed on a vehicle and the system including:
estimating means for estimating a force experienced by the tire as a function of a vehicle model and of a state observer,
means for estimating a force experienced by the tire as a function of a thermomechanical model of the tire,
means for statistical comparison of the forces determined during the first and second estimating steps, and
means for determining, as a function of the result of this comparison step, a value of the tire/ground adhesion potential.

According to one embodiment, the system is such that the various means are installed on the vehicle.

According to one embodiment, the system further includes sensors installed on the vehicle.

Other advantages and embodiments of the invention will be described in greater detail, in a non-limiting manner, with the aid of the figures, in which:

FIG. 1, already described, shows a normalized longitudinal friction force curve as a function of slip rate,

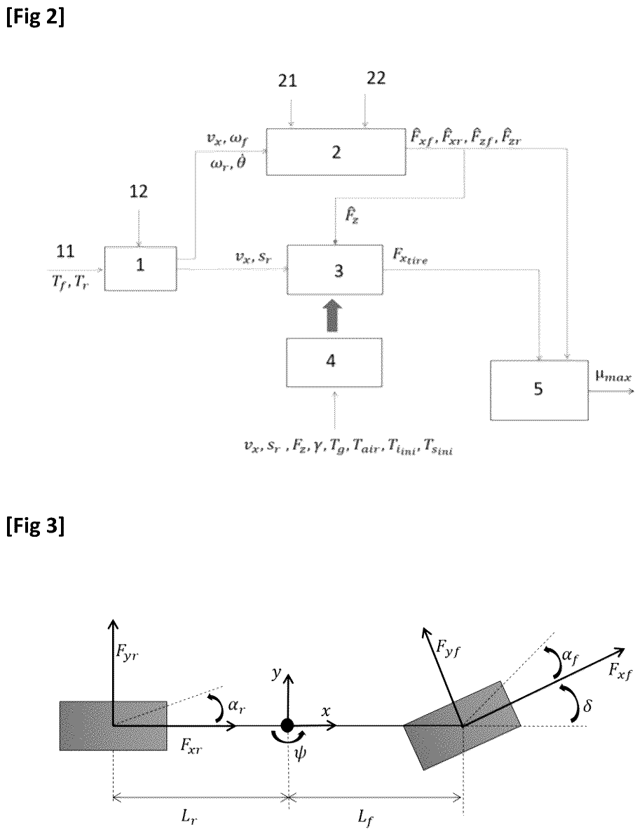

FIG. 2 is a block diagram outlining a method according to the invention,

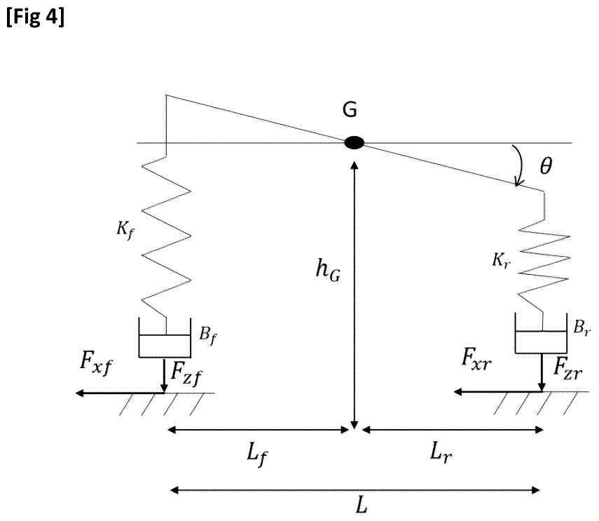

FIG. 3 and FIG. 4 are depictions of the forces acting on a vehicle in a model used in the present invention.

A method according to the invention includes several steps, employing various data, as illustrated in FIG. 2.

The table below indicates the meanings of the various parameters that appear in the figure, together with their units.

TABLE 1

| Variable | Units | Description |
|---|---|---|
| νₓ | m/s | Longitudinal vehicle speed |
| ω_{f}, ωᵣ | rad/s | Wheel speed (front and rear) |
| \dot{θ} | rad/s | Vehicle pitch speed |
| T_{f}, Tᵣ | N · m | Engine and braking torque |
| | | (front and rear) |
| F_{xf}, Fₓᵣ | N | Longitudinal friction force |
| | | (front and rear) |
| F_{zf}, F_{zr} | N | Vertical load (front and rear) |
| sᵣ | — | Slip rate |
| γ | rad | Camber |
| T_{g} | ° C. | Ground temperature |
| Tₐᵢᵣ | ° C. | Air temperature |
| Tᵢ_{ᵢₙᵢ} | ° C. | Initial internal tire temperature |
| Tₛ_{ᵢₙᵢ} | ° C. | Initial tire surface temperature |
| μₘₐₓ | — | Adhesion potential |

The tire considered is installed on a vehicle fitted with various sensors. On the basis of the vehicle's known engine and braking torque, and from data measured by the various sensors, a set of running parameters for the vehicle 11 is determined in block 1, including a longitudinal vehicle speed and a slip rate. Any disturbances 12 are also taken into consideration.

These data are then used to perform two steps of estimating the forces experienced by the tire. A first step, in block 2, consists in determining the forces experienced by the tire, according to a vehicle model 21 and to any disturbances 22.

A bicycle model, as shown in FIG. 3, is advantageously used that accounts for longitudinal dynamic changes and pitch variations. In order to take these pitch variations into account, it is also necessary to consider a suspension model, such as the one shown in FIG. 4.

The use of the bicycle model and the suspension model leads to the following state representation:

$$\{ \begin{matrix}\dot{x} = f ( x , u , t ) \\ y = h ( x , t )\end{matrix} \qquad [ Math 1 ]$$

$$With$$

$$\{ \begin{matrix}x = {[ {υ}_{x} , {ω}_{f} , {ω}_{r} , {F}_{xf} , {F}_{xr} , {\dot{F}}_{xf} , {\dot{F}}_{xr} , θ , \dot{θ} ]}^{T} \\ u = {[ {T}_{f} , {T}_{r} ]}^{T} \\ y = {[ {υ}_{x} , {ω}_{f} , {ω}_{r} , \dot{θ} ]}^{T}\end{matrix} \qquad [ Math 2 ]$$

$$And$$

$$f = [ \begin{matrix}{\dot{υ}}_{x} \\ {\dot{ω}}_{f} \\ {\dot{ω}}_{r} \\ {\dot{F}}_{xf} \\ {\dot{F}}_{xr} \\ {\ddot{F}}_{xf} \\ {\ddot{F}}_{xr} \\ \dot{θ} \\ \ddot{θ}\end{matrix} ] = [ \begin{matrix}\frac{1}{m} [ {F}_{xf} + {F}_{xr} - \frac{1}{2} {ρ}_{a} {S}_{a} {C}_{x} {υ}_{x}^{2} - {f}_{RR} ( {F}_{zf} + {F}_{zr} ) ] \\ \frac{1}{2 {I}_{wf}} [ {T}_{f} - ( R + αΔ {F}_{z} ) {F}_{xf} ] \\ \frac{1}{2 {I}_{wr}} [ {T}_{r} - ( R - αΔ {F}_{z} ) {F}_{xr} ] \\ {\dot{F}}_{xf} \\ {\dot{F}}_{xr} \\ 0 \\ 0 \\ \dot{θ} \\ \frac{1}{{I}_{y}} [ ( {F}_{xf} + {F}_{xr} - {F}_{RR} ) {h}_{G} - {F}_{zf} {L}_{f} + {F}_{zr} {L}_{r} ]\end{matrix} ] and h = [ \begin{matrix}{\dot{υ}}_{x} \\ {\dot{ω}}_{f} \\ {\dot{ω}}_{r} \\ \dot{θ}\end{matrix} ] \qquad [ Math 3 ]$$

The state observer used is an extended Kalman filter.

The main assumptions of the bicycle model are as follows:
front-left steering angles=front-right steering angles,
rear steering angles are zero,
vehicle moving on level ground (no banking).

Furthermore, in this model, the effects of pitching and rolling are often neglected. In the present example, the roll dynamics are indeed neglected but the pitch dynamics are not since a suspension system is being considered.

A second step, in block 3, estimates the forces experienced based upon a thermomechanical model 4. This model is determined from a set of parameters, notably temperature. Using this model, it is possible to calculate the values of mu as a function of slip rate under the tire operating conditions encountered (at the pressure, load, temperature, etc. encountered at the time of calculation) in order to determine the max adhesion potential for the mu₀ value supplied to the model. By repeating this procedure for different settings of mu₀, a list of muₘₐₓ values corresponding to different possible levels of ground adhesion is obtained.

In an advantageous embodiment, the initial model is reduced to enable less resource-intensive calculations and therefore easier to embed directly in a vehicle. The results of blocks 2 and 3 are then compared, in a step 5, to determine an adhesion potential.

The comparison between the forces estimated in the preceding two parts is performed here using a Bayesian logic approach. This type of approach has the advantage of providing an associated probability in addition to the value sought. In order to implement it, it is first necessary to make an assumption regarding the probability density of the estimated forces knowing the adhesion potential. Because the Kalman filter works by considering Gaussian noise, the selected probability density has the form of a Gaussian distribution. Therefore one has:

$$p r [ \hat{F} \vert {μ}_{max} ] = \frac{1}{{( 2 π )}^{n / 2} {\vert S \vert}^{1 / 2}} exp ( \frac{1}{2} {( \hat{F} - {F}_{t i r e} )}^{T} {{S}^{- 1} ( \hat{F} - {F}_{t i r e} )}^{T} ) \qquad [ Math 4 ]$$

The Bayes formula is then used to determine the probability of the adhesion potential knowing the friction force, which gives:

$$Pr [ {μ}_{j} \vert {\hat{F}}_{k} ] = \frac{Pr [ {\hat{F}}_{k} \vert {μ}_{j} ] Pr [ {μ}_{j} \vert {\hat{F}}_{k - 1} ]}{{\sum }_{i = 1}^{J} Pr [ {\hat{F}}_{k} \vert {μ}_{i} ] Pr [ {μ}_{i} \vert {\hat{F}}_{k - 1} ]} \qquad [ Math 5 ]$$

The adhesion coefficient is thus obtained by calculating the weighted sum:

$${\hat{μ}}_{k} = {\sum }_{i = 1}^{J} Pr [ {μ}_{j} \vert {\hat{F}}_{k} ] {μ}_{j} \qquad [ Math 6 ]$$

The adhesion potential is therefore the maximum of this weighted sum.

In another example, use is made not of a Bayesian method but of a Monte-Carlo Markov Chain method, known as MCMC.

In a Bayesian method, μ is treated as a discrete random variable, so the denominator of the Bayes' formula is an easily calculated discrete sum. By using the MCMC method, it is possible to consider μ as a continuous random variable, thus achieving greater precision. However, in that case, the denominator of the Bayes' formula is no longer a discrete sum but an integral, which is more complicated to calculate. The MCMC method therefore proposes the calculation of probability density ratios in order to dispense with the need for the denominator. This method also has the advantage of working with low-load measurements. In this approach, these measurements are the forces estimated using the Kalman filter.

Thus, a method according to the invention provides a reliable estimate of adhesion potential. The invention has been described in detail for the longitudinal case.

Nevertheless, this description is not restrictive, and a similar approach could be envisioned for the lateral, or a combination of both.

1.-10. (canceled)

11. A method for estimating adhesion potential of a tire on a rolling surface, the tire being installed on a vehicle, and the method comprising the following steps:
a first step of estimating a force experienced by the tire as a function of a vehicle model and a state observer;
a second step of estimating a force experienced by the tire as a function of a thermomechanical model of the tire;
a step of statistically comparing the forces determined during the first and second estimating steps, and
a step of determining, as a function of a result of the comparing step, a value of the adhesion potential of the tire on the rolling surface.

12. The estimation method according to claim 11, wherein the vehicle model is a bicycle model, and
wherein the state observer is a Kalman filter.

13. The estimation method according to claim 11, wherein the comparing step employs a Bayesian logic method.

14. The estimation method according to claim 11, wherein the comparing step employs a Monte-Carlo Markov Chain method.

15. The estimation method according to claim 11, wherein the thermomechanical model of the tire comprises a model of longitudinal forces, transverse forces, a self-aligning torque and a balance of elementary shearing and slipping forces of the tire at a transition point between adhering and sliding contact regions.

16. The estimation method according to claim 11, further comprising, at least before the second estimating step, a step of reducing the tire model.

17. The estimation method according to claim 11, wherein all of the steps are performed in real time.

18. A system for estimating a tire's adhesion potential on a rolling surface, the tire being installed on a vehicle, and the system comprising:
means for estimating a force experienced by the tire as a function of a vehicle model and of a state observer;
means for estimating a force experienced by the tire as a function of a thermomechanical model of the tire;
means for statistically comparing the forces determined during the first and second estimating steps; and
means for determining, as a function of a result of the comparing step, a value of the adhesion potential on the rolling surface.

19. The estimation system according to claim 18, wherein the means are installed on the vehicle.

20. The estimation system according to claim 18, further comprising sensors installed on the vehicle.
